(19) United States
(12) Patent Application Publication
(10) Pub. No.: US 2010/0315920 A1
(43) Pub. Date: Dec. 16, 2010

(54) EXTERNAL OPTICAL DISC DRIVE AND METHOD OF CONTROLLING THE SAME

(75) Inventors: Chih-Hsiung HUA, Hsinchu (TW); Ing-Ming LEE, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: LITE-ON IT CORP., Taipei City (TW)

(21) Appl. No.: 12/778,285

(22) Filed: May 12, 2010

(30) Foreign Application Priority Data
Jun. 16, 2009 (CN) 200910147507.9

(51) Int. Cl. G11B 19/00; G05B 15/02

(52) U.S. Cl. 369/47.38; 700/275; 713/300; G9B/19

(57) ABSTRACT

An external optical disc drive, connected to a bus from which a supplying voltage and a supplying current are outputted, includes: a voltage detector connected to the bus for receiving and detecting the supplying voltage; a digital signal processor connected to the voltage detector; a motor driver connected to the digital signal processor; and a spindle motor connected to the motor driver; wherein a speed-control signal, for informing the digital signal processor to lower the speed of the spindle motor via the motor driver, is outputted to the digital signal processor from the voltage detector while the supplying voltage is detected lower than a threshold voltage.

### FIELD OF THE INVENTION

The present invention relates to a universal serial bus (USB) external optical disc drive, and more particularly to a USB external optical disc drive can be dynamically operated at various speeds based on a detected supplying voltage.

### BACKGROUND OF THE INVENTION

USB specification is developed by Microsoft and Intel. In the USB specification, the standard supplying voltage and the supplying current outputted from a USB port are 5V and 0.5 A, respectively.

FIG. 1 is a block diagram illustrating a system of a USB external device connected to a computer host via a USB port. The system comprises a computer host 10 and a USB external device 12, where the USB external device 12 is a low-power-consumption device. The computer host 10 further comprises a USB port 102. In a standard interface of USB specification, there are four terminals including a positive-data terminal (D+), an negative-data terminal (D−), a positive-power terminal (V+), and a ground terminal (GND). The positive-data terminal (D+) and the negative-data terminal (D−) are used for the data transmission between the computer host 10 and the USB external device 12; the positive-power terminal (V+) is used for providing the driving powers (supplying voltage and supplying current) to the USB external device 12 from the computer host 10; and the ground terminal (GND) is connected to ground. The USB external device 12 also comprises a positive-data terminal (D+), a negative-data terminal (D−), a positive-power terminal (V+), and a ground terminal (GND). The positive-data terminal (D+), negative-data terminal (D−), positive-power terminal (V+), and ground terminal (GND) of the USB external device 12 are connected to the positive-data terminal (D+), negative-data terminal (D−), positive-power terminal (V+), and ground terminal (GND) of the USB port 102, respectively.

Because the USB external device 12 is a low-power-consumption device, such as a USB thumb drive or a MP3 device, the power consumption (or supplying current) demanded by the USB external device 12 is lower than the standard supplying current (0.5 A) provided by the USB port 102, so as the USB external device 12 can work properly if the USB external device 12 is directly connected to the host 10 via one USB port 102.

However, once the USB external device is a high-power-consumption device, such as a USB external hard drive, the USB external device may not work properly while the USB external device is connected to the host via only one USB port. FIG. 2 is a block diagram illustrating a system of a USB external device connected to a computer host via two USB ports. The system comprises the computer host 10 and a USB external device 14, where the USB external device 14 is a high-power-consumption device. The computer host 10 further comprises a first USB port 104 and a second USB port 106. Each of the first USB port 104 and the second USB port 106 comprises a positive-data terminal (D+), a negative-data terminal (D−), a positive-power terminal (V+), and a ground terminal (GND). Because the USB external device 14 is a high-power-consumption device and the supplying current demanded by the USB external device 14 is relative high (say, 1 A), the USB external device 14 must be connected to the host 10 via both the first USB port 104 and the second USB port 106, so as a full supplying current can be provided to the USB external device 14. That is, the positive-power terminal (V+) of the USB external device 14 is coupled in parallel to both the positive-power terminals (V+) of the first USB port 104 and the second USB port 106; the ground terminal (GND) of the USB external device 14 is coupled in parallel to both the ground terminals (GND) of the first USB port 104 and the second USB port 106; the positive-data terminal (D+) and the negative-data terminal (D−) of the USB external device 14 are connected to either the positive-data terminal (D+) and the negative-data terminal (D−) of the first USB port 104 or the second USB port 106. Because both the first USB port 104 and the second USB port 106 can provide the standard supplying current (0.5 A), the USB external device 14 can get full supplying current (1 A) while the USB external device 14 is connected to the host 10 via both the first USB port 104 and the second USB port 106 coupled in parallel, so as the high-power-consumption USB external device 14 can work properly.

However, an extra power adapter may be necessary if the supplying current demanded by a high-power-consumption USB external device is over than 1 A which is the maximum supplying current can be provided by two USB ports coupled in parallel. FIG. 3 is a block diagram illustrating a system of a USB external device connected to a computer host via a USB port and powered by a power adapter. The system comprises the computer host 10, a USB external device 16, and a power adopter 17. The USB external device 16 is a high-power-consumption device, such as a USB external optical disc drive, and the maximum supplying current demanded by the USB external device 16 is higher than 1 A. The computer host 10 further comprises a USB port 108. The power adapter 17 further comprises a plug 18 to which an AC power is transmitted. Because the USB external device 16 is a high-power-consumption device and the supplying current demanded by the USB external device 16 is higher than 1 A, the USB external device 16 must be powered by the power adapter 17, so as the high-power-consumption USB external device 16 can work properly.

FIG. 4 is a functional block diagram illustrating a conventional USB external optical disc drive. The optical disc drive 20 mainly comprises an optical pickup head 210, a spindle motor 220, a sled motor 230, a radio-frequency amplifier 250, a first motor driver 260, a second motor driver 265, and a DSP (Digital Signal Processor) 270. The spindle motor 220 is used for spinning an optical disc 22. The optical pickup head 210 is driven by the sled motor 230 and an actuator including a tracking coil 240 and a focusing coil 245. The sled motor 210 is used for a long-distance movement of the optical pickup head 210; the tracking coil 240 and the focusing coil 245 are used for a small-distance movement of the lens 1 of the optical pickup head 210.

An electric signal is generated and transmitted to the radio-frequency amplifier 250 while the data stored on the optical disc 22 is retrieved by the optical pickup head 210. Afterwards, three output signals including radio-frequency signal (RF), tracking error signal (TE), and focusing error signal (FE) are outputted to the DSP 270 from the radio-frequency amplifier 250 after the electric signal is received and processed by the radio-frequency amplifier 250. Afterwards, DSP 270 controls the first motor driver 260 to generate a sled-motor driving signal, a tracking-coil driving signal, and a focusing-coil driving signal. Also, DSP 270 controls the second motor driver 265 to generate a spindle-motor driving signal.

As known in the art, the sled-motor driving signal, the tracking-coil driving signal and the focusing-coil driving signal are capable of moving the optical pickup head 210 and lens 1 to a correct track and a correct focus position. Also, the spindle-motor driving signal is capable of controlling the spindle motor 220 to spin the optical disc 22 at a proper speed. Moreover, the process of moving the lens 1 to a correct disc position at a proper speed can be defined as tracking action.

Generally, the speed of the optical disc drive 20 means the rotating speed of the spindle motor 220. That is, if the speed of the optical disc drive 20 is relative high, the rotating speed of the spindle motor 220 is relative high, so as the speed of retrieving data from (or writing data to) the optical disc 22 is relative high. For example, it will take about 57 minutes to completely burn a DVD disc if the optical disc drive 20 is an one-speed optical disc drive (1×-speed); it will take about 28 minutes to completely burn a DVD disc if the optical disc drive 20 is a two-speed optical disc drive (2×-speed); and it will take about 14 minutes to completely burn a DVD disc if the optical disc drive 20 is a four-speed optical disc drive (4×-speed). Moreover, it is understood that a higher supplying current is demanded by the optical disc drive 20 if the spindle motor 220 is operated at a higher speed.

A USB external optical disc drive is implemented via introducing a USB port in an optical disc drive. Because the spindle motor 220, the sled motor 230, and the actuator (the tracking coil 240 and the focusing coil 245) are all in action while the USB external optical disc drive is executing the tracking action, the supplying current demanded by the USB eternal optical disc drive is higher than 1 A, so as the USB external optical disc drive must be powered via the power adapter 17 as depicted in FIG. 3. However, using a USB external optical disc drive via a power adapter is quite inconvenient to a user. Because the user needs to carry the power adapter to use the USB external optical disc drive.

### SUMMARY OF THE INVENTION

Therefore, the present invention relates to a USB external optical disc drive can work without a power adapter. The USB external optical disc drive can be dynamically operated at various speeds based on an inputted supplying voltage.

The present invention provides an external optical disc drive, connected to a bus from which a supplying voltage and a supplying current are outputted, comprising: a voltage detector connected to the bus for receiving and detecting the supplying voltage; a digital signal processor connected to the voltage detector; a motor driver connected to the digital signal processor; and a spindle motor connected to the motor driver; wherein a speed-control signal, for informing the digital signal processor to lower the speed of the spindle motor from a first speed to a second speed via the motor driver, is outputted to the digital signal processor from the voltage detector while the supplying voltage is detected to be lower than a threshold voltage.

The present invention provides a control method for an external optical disc drive connected to a bus from which a supplying voltage and a supplying current is outputted, comprising steps of: detecting the supplying voltage at the bus; operating the external optical disc drive at a first speed while the supplying voltage is not lower than a threshold voltage; and operating the external optical disc drive at a second speed while the supplying voltage is lower than the threshold voltage; wherein the first speed is higher than the second speed.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram illustrating a system of a USB external device connected to a computer host via a USB port;

FIG. 2 is a block diagram illustrating a system of a USB external device connected to a computer host via two USB ports;

FIG. 3 is a block diagram illustrating a system of a USB external device connected to a computer host via a USB port and powered by a power adapter;

FIG. 4 is a functional block diagram illustrating a conventional optical disc drive;

FIG. 5 is a functional block diagram illustrating a USB external optical disc drive of the present invention; and

FIG. 6 is a flow chart illustrating a control method to use with the optical disc drive of the present invention.

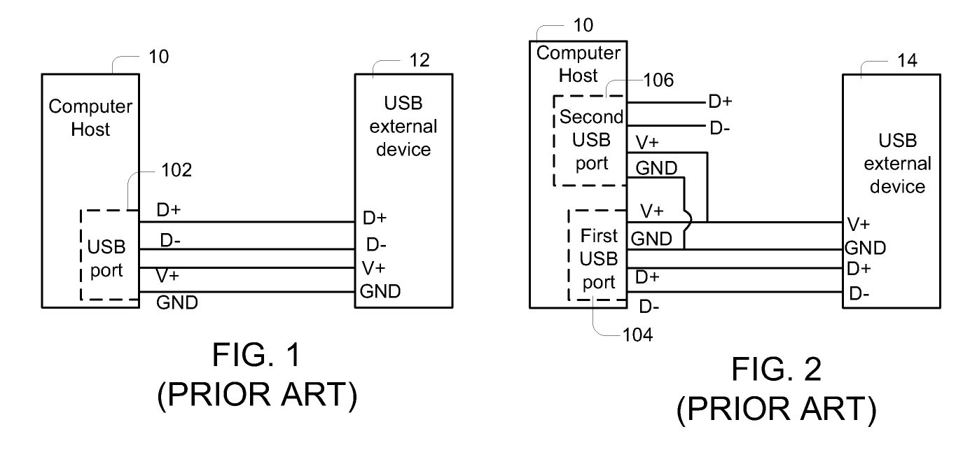

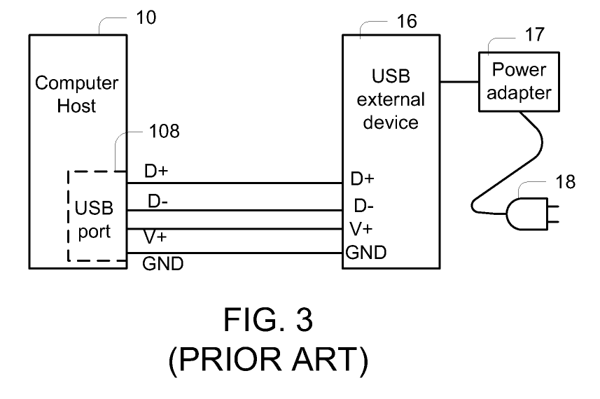

### DETAILED DESCRIPTION OF PREFERRED EMBODIMENTS

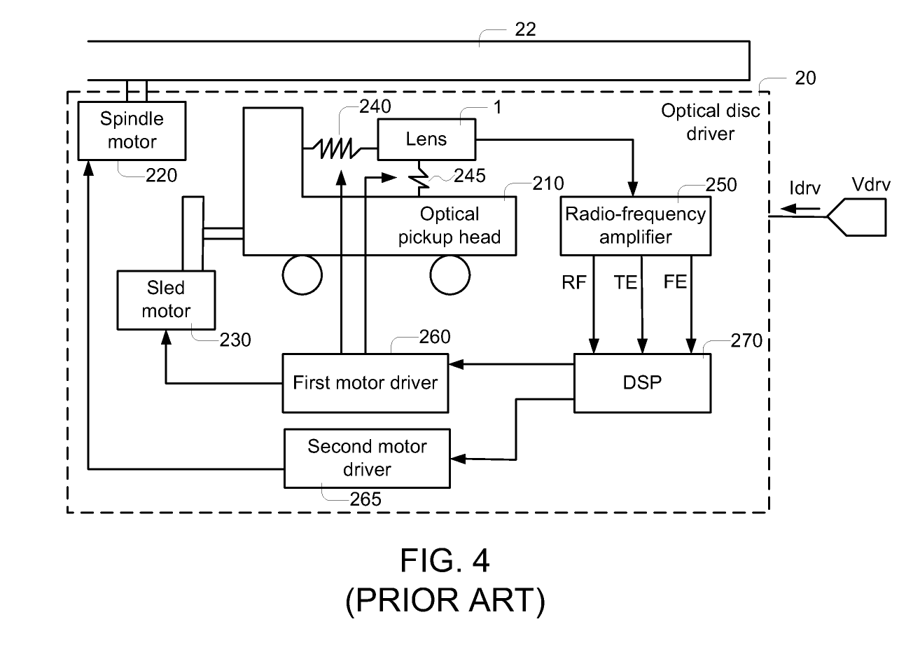

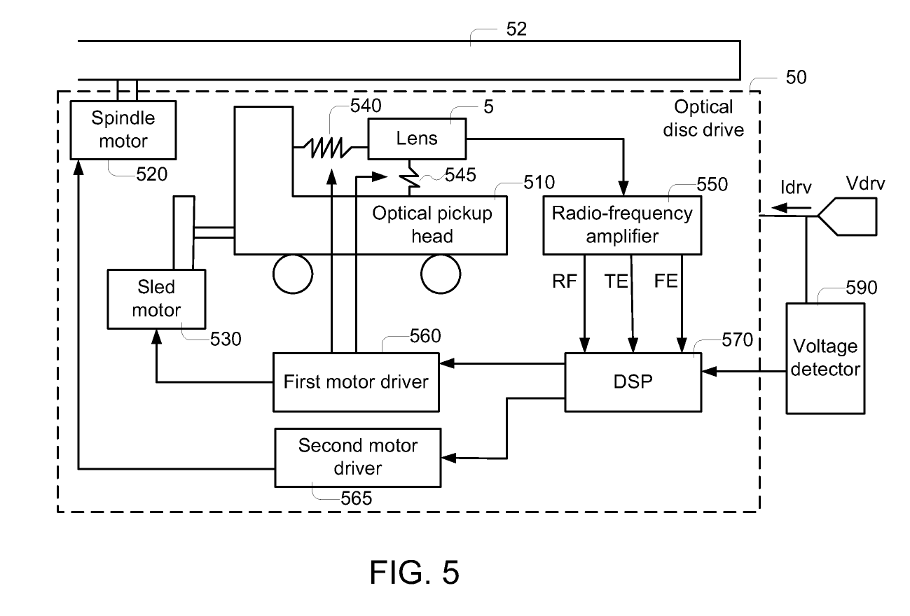

FIG. 5 is a functional block diagram illustrating a USB external optical disc drive of the present invention. Similar to the conventional optical disc drive depicted in FIG. 4, the USB external optical disc drive 50 mainly comprises an optical pickup head 510, a spindle motor 520, a sled motor 530, a radio-frequency amplifier 550, a first motor driver 560, a second motor driver 565, and a DSP 570. The spindle motor 520 is used for spinning an optical disc 52. The optical pickup head 510 is driven by the sled motor 530 and an actuator including a tracking coil 540 and a focusing coil 545. The sled motor 530 is used for a long-distance movement of the optical pickup head 510; the tracking coil 540 and the focusing coil 545 are used for a small-distance movement of the lens 5 of the optical pickup head 510.

As descried above, an electric signal is generated and transmitted to the radio-frequency amplifier 550 while the data stored on the optical disc 52 is retrieved by the optical pickup head 510. Afterwards, DSP 570 controls the first motor driver 560 to generate a sled-motor driving signal, a tracking-coil driving signal, and a focusing-coil driving signal. Also, DSP 570 controls the second motor driver 565 to generate a spindle-motor driving signal.

The sled-motor driving signal, the tracking-coil driving signal and the focusing-coil driving signal are capable of moving the optical pickup head 510 and lens 5 to a correct track and a correct focus position. Also, the spindle-motor driving signal is capable of controlling the spindle motor 520 to spin the optical disc 52 at a proper speed.

To guarantee the optical disc drive of the invention can always work properly without being powered via a power adapter, a voltage detector is introduced in the optical disc drive of the invention. The optical disc drive of the invention can be operated at various speed based on the detected supplying voltage.

As depicted in FIG. 5, the supplying voltage (Vdrv) outputted from the positive-power terminal (V+) of a USB port can be detected by the voltage detector 590. In the embodiment, a speed-control signal with a first level, for informing the DSP 570 to lower the speed of the spindle motor 520, is outputted from the voltage detector 590 while the detected supplying voltage (Vdrv) is dropped under the threshold voltage (say, 4.5V). Because the spindle motor 520 is the main component to consume the supplying current (Idrv), the required supplying current (Idrv) is decreased if the spindle motor 520 is operated at a lower speed, so as the supplying voltage (Vdrv) will turn to increase. Because the supplying voltage (Vdrv) is increased higher than the threshold voltage (4.5V), the optical pickup head 510 in the invention is guaranteed to always work properly.

On the other hand, if the supplying voltage (Vdrv) is detected to rise higher than the threshold voltage (4.5V) due to the lower speed of the spindle motor 520 for a while, a speed-control signal with a second level, for informing the DSP 570 to increase the speed of the spindle motor 520, is outputted from the voltage detector 590. So that the optical disc drive 50 is operated at the relative high speed and a better performance is obtained.

For example, the supplying voltage (Vdrv) may drop under the threshold voltage (4.5V) while the required supplying current (Idrv) is instantly raised to 1.1 A when the optical disc drive 50 is operated at a first speed (say, 32×-speed) executing the tracking action. Once the supplying voltage (Vdrv) is detected lower than the threshold voltage (4.5V), a speed-control signal with a first level, for informing the DSP 570 to lower the speed of the spindle motor 520 to a second speed (say, 16×-speed), is outputted from the voltage detector 590. Then the required supplying current (Idrv) is decreased and the supplying voltage (Vdrv) is increased to the threshold voltage (4.5V).

It is to be understood that the invention needs not be limited to restrict the speed of the spindle motor 520 either at the first speed (32×-speed) or the second speed (16×-speed). The speed of the spindle motor 520 can be further lowered if necessary. That is, if the supplying voltage (Vdrv) is detected still lower than the threshold voltage (4.5V) after the spindle motor 520 is switched to operate at the second speed (16×-speed) from the first speed (32×-speed) for a while, a speed-control signal with a third level, for informing the DSP 570 to further lower the speed of the spindle motor 520 to a third speed (say, 8×-speed), is outputted from the voltage detector 590. Then the required supplying current (Idrv) is further decreased and the supplying voltage (Vdrv) is increased to the threshold voltage (4.5V). In the embodiment, the speed of the spindle motor 520 can be lowered to a minimum speed (say, 1×-speed) to guarantee the supplying voltage is maintained higher than the threshold voltage (4.5V), where the optical pickup head 510 can work properly at the minimum speed (1×-speed).

On the other hand, if the supplying voltage (Vdrv) is detected higher than the threshold voltage (4.5V) due to the spindle motor 520 is switched to operate at the second speed (16×-speed) from the first speed (32×-speed), a speed-control signal with a fourth level, for informing the DSP 570 to increase the speed of the spindle motor 520 at a fourth speed (say, 20×-speed or 32×-speed), is outputted from the voltage detector 590.

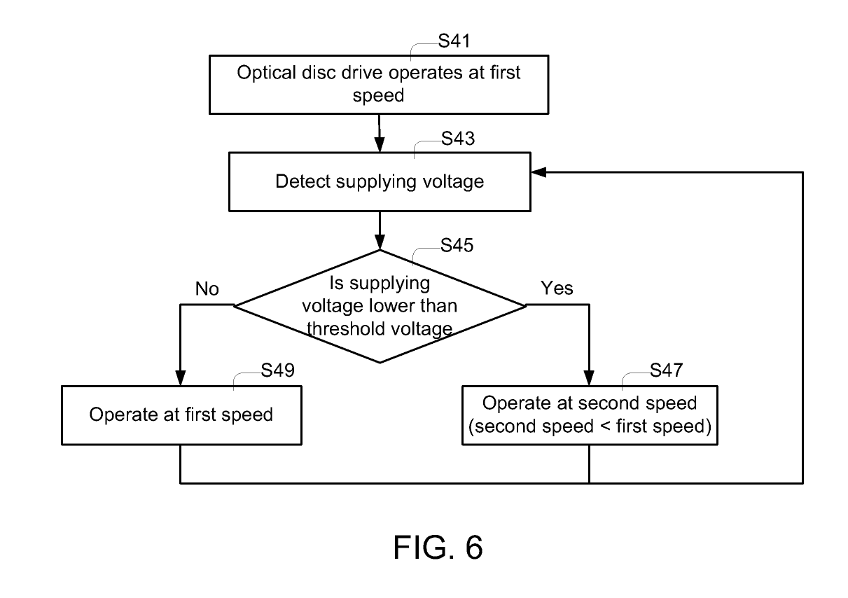

FIG. 6 is a flow chart illustrating a control method to use with the optical disc drive of the present invention. First, operate the optical disc drive at a first speed, that is, operate the spindle motor to rotate at a first speed (step 41). Afterwards, detect the supplying voltage consumed by the optical disc drive (step 43). Afterwards, determine the supplying voltage is whether less than the threshold voltage (step 45). Operate the spindle motor to rotate at a second speed while the supplying voltage is detected lower than the threshold voltage (step 47), where the second speed is lower than the first speed. Or, maintain the spindle motor to rotate at the first speed if the supplying voltage is still higher than the threshold voltage (step 49).

To sum up, when the optical disc drive of the invention may not work properly as a result of the supplying voltage is lower than the threshold voltage, a speed-control signal, for informing the DSP to operate the spindle motor at a lower speed, is outputted to the DSP from the voltage detector. Accordingly, the required supplying current is decreased, so as the supplying voltage is increased and the optical disc drive is guaranteed to have a proper function.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An external optical disc drive, connected to a bus from which a supplying voltage and a supplying current are outputted, comprising:
a voltage detector connected to the bus for receiving and detecting the supplying voltage;
a digital signal processor connected to the voltage detector;
a motor driver connected to the digital signal processor; and
a spindle motor connected to the motor driver;
wherein a speed-control signal, for informing the digital signal processor to lower the speed of the spindle motor from a first speed to a second speed via the motor driver, is outputted to the digital signal processor from the voltage detector while the supplying voltage is detected to be lower than a threshold voltage.

2. The external optical disc drive according to claim 1 wherein the bus is a universal serial bus and the supplying voltage is outputted from a positive-voltage terminal of the universal serial bus.

3. The external optical disc drive according to claim 1 wherein the supplying voltage is decreased while the supplying current is increased.

4. The external optical disc drive according to claim 1 wherein the supplying voltage is 5V and the threshold voltage is 4.5V.

5. The external optical disc drive according to claim 1 wherein the speed-control signal, for informing the digital signal processor to increase the second speed to a third speed of the spindle motor via the motor driver, is outputted to the digital signal processor from the voltage detector while the supplying voltage is detected to be higher than the threshold voltage.

6. The external optical disc drive according to claim 1 wherein the speed-control signal, for informing the digital signal processor to further decrease the second speed to a fourth speed of the spindle motor via the motor driver, is outputted to the digital signal processor from the voltage detector while the supplying voltage is detected to be lower than the threshold voltage.

7. A control method for an external optical disc drive connected to a bus from which a supplying voltage and a supplying current is outputted, comprising steps of:
detecting the supplying voltage of the bus;
operating the external optical disc drive at a first speed while the supplying voltage is not lower than a threshold voltage; and
operating the external optical disc drive at a second speed while the supplying voltage is lower than the threshold voltage;
wherein the first speed is higher than the second speed.

8. The method according to claim 7 wherein the bus is a universal serial bus and the supplying voltage is outputted from a positive-voltage terminal of the universal serial bus.

9. The method according to claim 7 wherein the supplying voltage is decreased while the supplying current is increased.

10. The method according to claim 7 wherein the supplying voltage is 5V and the threshold voltage is 4.5V.

11. The method according to claim 7 further comprising steps of:
detecting the supplying voltage while the external optical disc drive is operated at the second speed;
operating the external optical disc drive at a third speed while the supplying voltage is still lower than the threshold voltage; and
operating the external optical disc drive system at a fourth speed while the supplying voltage is higher than the threshold voltage;
wherein the second speed is higher than the third speed, the fourth speed is higher than the second speed.
